(19) United States
(12) Patent Application Publication
(10) Pub. No.: US 2015/0083451 A1
(43) Pub. Date: Mar. 26, 2015

(54) POWER TOOL

(71) Applicant: HITACHI KOKI CO., LTD., Tokyo (JP)

(72) Inventor: Tomomasa Nishikawa, Hitachinaka (JP)

(73) Assignee: HITACHI KOKI CO., LTD., Tokyo (JP)

(21) Appl. No.: 14/386,611

(22) PCT Filed: Mar. 4, 2013
(86) PCT No.: PCT/JP2013/001319

§ 371 Date: Sep. 19, 2014

(30) Foreign Application Priority Data
Mar. 30, 2012 (JP) 2012-080671

(51) Int. Cl. B25B 21/02; B25D 16/00

(52) U.S. Cl. CPC B25B 21/026; B25D 16/003; B25D 16/006
USPC 173/48; 173/47

(57) ABSTRACT

A power tool having an impact mechanism part using a hammer 24 and an anvil 31 is provided with a switching mechanism 35 of a mode in which the hammer 24 impacts the anvil 31 while the hammer is placed over the anvil 31 and another impact mode in which the hammer 24 impacts the anvil 31 without being placed over the anvil 31. The switching mechanism 35 includes a stopper 41 and a pusher 45 disposed in the rear of the hammer 24, and the stopper 41 is moved to carry out switching by rotating the pusher 45. The change member 48 that rotates the pusher 45 has a change lever 48b, which is positioned in the outer side of the hammer case 32, and the change member 48 and an annular part 46 are engaged in a housing.

### TECHNICAL FIELD

The present invention relates to a mechanism and a structure of mode switching of a power tool having a plurality of operation modes.

### BACKGROUND ART

An impact driver is a tool for carrying out fastening operations of screws and bolts. The impact driver is provided with an impact mechanism part including a hammer and an anvil. The hammer continuously impacts the anvil while rotating. The hammer impacts the anvil, then is placed over the anvil, moves over the anvil, and impacts the anvil again. The impact driver can obtain high fastening torque; however, large sound is produced since a fastening material is impacted in the axial direction of the fastening material.

In recent years, an impact driver in which a hammer which impacts an anvil is not moved in the axial direction of rotation has been known. This impact driver of a new system is known as an “electronic pulse driver” which is a product of the applicants. As described in Japanese Patent Application Laid-Open Publication No. 2011-31313 (Patent Document 1), the electronic pulse driver is a tool for carrying out fastening operations similar to those of conventional power tools for carrying out impact operations while a hammer is being retracted in the axial direction. However, in the electronic pulse driver, the hammer is not placed over the anvil. In the electronic pulse driver, when the motor is rotated in normal direction and opposite direction, the hammer is rotated in normal direction and opposite direction, and impact force is applied to the anvil. Therefore, since a fastening material is not struck in the axial direction of the fastening material by the electronic pulse driver, the electronic pulse driver has a low noise level. However, it has been difficult to obtain high fastening torque for the electronic pulse driver as compared with a conventional power tool for carrying out impact operations while the hammer is being retracted in the axial direction.

In order to solve these problems, a fastening tool in which a mechanism part, which limits the operation that the hammer is placed over the anvil (backward movement of the hammer in the axial direction), is provided in a hammer case is proposed in Japanese Patent Application Laid-Open Publication No. 2012-11502 (Patent Document 2). This fastening tool is capable of switching between an operation mode (impact mode) in which an impact operation is carried out while the hammer is being retracted in the axial direction and an operation mode (electronic pulse mode) in which the impact operation is carried out without retracting the hammer in the axial direction.

### CITATION LIST

### Patent Literature

PTL 1: Japanese Patent Application Laid-Open Publication No. 2011-31313
PTL 2: Japanese Patent Application Laid-Open Publication No. 2012-11502

### SUMMARY OF INVENTION

### Technical Problem

In the fastening tool proposed by Patent Document 2, a switching mechanism of the operation modes includes a stopper and a pusher disposed in the hammer case. When the pusher is rotated, the stopper is moved, and the operation mode is switched. Specifically, the stopper moves to the hammer side, which is in the front of the pusher, and prevents backward movement of the hammer. However, since an operation part for operating the pusher is operated by a hand of an operator, the operation part has to penetrate from the inside of the hammer case to outside. Therefore, there has been a problem that an opening is formed in part of the hammer case, and grease is easily leaked from the opening.

An object of the present invention is to provide a power tool having a switching mechanism of a mode that allows backward movement of a hammer and a mode that prevents the movement, wherein an opening formed in a hammer case is configured so as not to be exposed to outside, and leakage of grease from the opening to outside is suppressed.

### Solution to Problem

The typical ones of the inventions disclosed in the present application will be briefly described as follows.

According to an aspect of the present invention, a power tool includes: a housing that houses a driving source; a case that houses a transmission mechanism part driven by the driving source and is partially covered with the housing; and a switching member that changes an operation mode of the transmission mechanism part from outside. The switching member is extending from outside of the housing and the case to the transmission mechanism part in the case through a part between the housing and the case.

### Advantageous Effects of Invention

The switching member that changes the operation mode from outside is extending from outside of the case to the transmission mechanism part in the case through the part between the housing and the case. Therefore, the connecting part of the switching member and the transmission mechanism part is covered with the housing, and grease leakage from the inside of the case is effectively prevented.

The effects obtained by typical aspects of the present invention will be briefly described below.

### BRIEF DESCRIPTION OF DRAWINGS

FIG. 1 is a vertical cross-sectional view illustrating an overall configuration of a power tool 1 (impact driver) according to an embodiment of the present invention.

FIG. 2 is a perspective view illustrating an external shape of a housing 2 and a hammer case 32 in FIG. 1.

FIG. 3 is an exploded perspective view illustrating an assembled structure of the hammer case, an impact mechanism part, and a switching mechanism 35 in FIG. 1.

FIG. 4 is a perspective view (normal position) of a impact mechanism part and the switching mechanism 35 in FIG. 1.

FIG. 5 is a perspective view (locked position) of the impact mechanism part and the switching mechanism 35 in FIG. 1.

FIG. 6A is a schematic diagram for explaining the shapes of a stopper 41 and a pusher 45 of the switching mechanism 35.

FIG. 6B is a schematic diagram for explaining the shapes of the stopper 41 and the pusher 45 of the switching mechanism 35.

FIG. 7 is a cross-sectional view of a change lever 48b part of the switching mechanism 35 in FIG. 1.

### DESCRIPTION OF EMBODIMENTS

### Embodiment 1

Hereinafter, embodiments of the present invention will be described in detail with reference to the accompanying drawings. Note that components having the same function are denoted by the same reference symbols throughout the drawings for describing the embodiment, and the repetitive description thereof will be omitted. In the present specification, explanations will be given on the assumption that front/rear and top/bottom directions are the directions shown in the drawings.

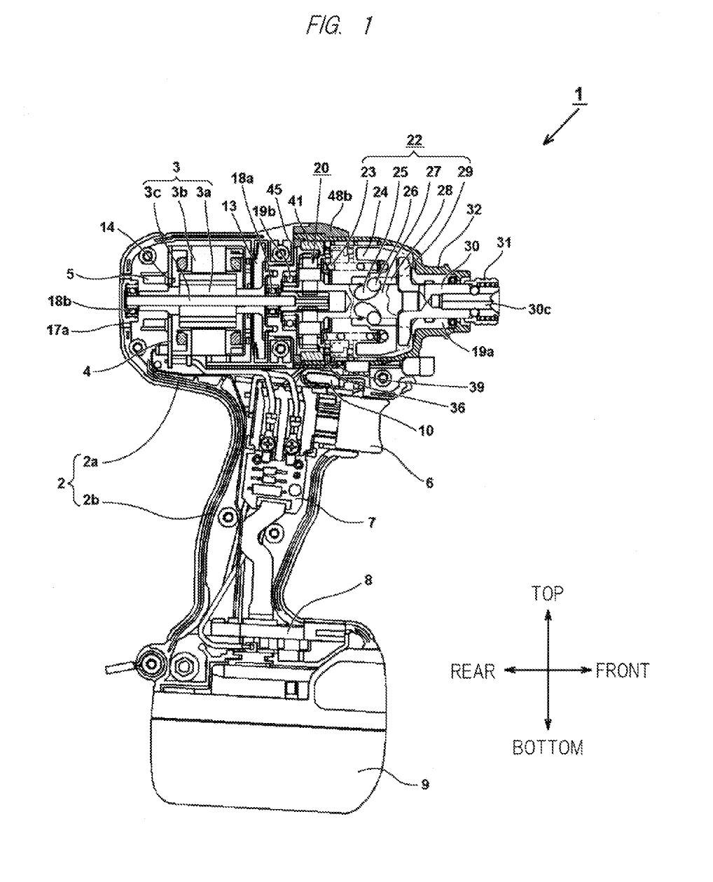

FIG. 1 is a diagram illustrating an internal structure of a power tool 1 according to the present invention. In the power tool 1, a chargeable battery 9 serves as a power source, a rotary impact mechanism part 22 is driven while using a motor 3 as a driving source, and rotative force and impact force are applied to an anvil 30, which is an output shaft. When the rotative force and the impact force are applied to the anvil 30, rotation impact force is intermittently transmitted to a tip tool, which is not illustrated, such as a driver bit retained by an anvil angular-hole part 30c covered with an attachment member 31, and a screw or a bolt is fastened by the tip tool.

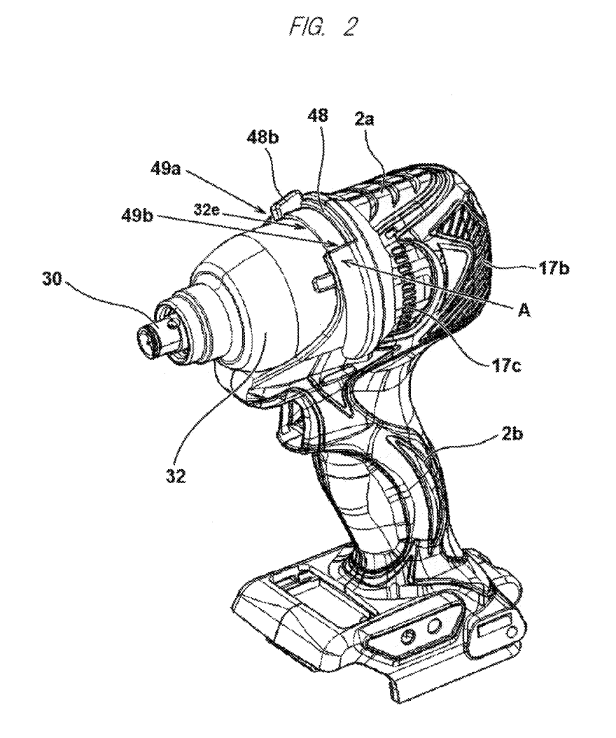

A chassis of the power tool 1 includes a housing 2, which is formed of a synthetic resin material, and a metal case (hammer case 32), which is attached to the front side of the housing and having a part thereof covered with the housing 2. The hammer case 32 forms a cup-shape having an opening in the rear side, and a through hole through which an output shaft is penetrating is formed in a bottom part (front-end part) of the case. The motor 3 of a brushless DC type is housed in a tubular body part 2a of the housing 2, which forms an approximately T-shape in a lateral view. A rotary shaft 3c of the motor 3 is rotatably retained by a bearing 18a, which is provided in a vicinity of a center part of the body part 2a of the housing 2, and a bearing 18b in the rear side. A rotor fan 13, which is attached coaxially with the rotary shaft 3c and is rotated in synchronization with the motor 3, is provided in the front of the motor 3. An inverter circuit board 4 for driving the motor 3 is disposed in the rear of the motor 3. When the rotor fan 13 is rotated, outside air is taken into the interior of the body part 2a from an air intake hole 17a and slots 17b (see FIG. 2), which are formed in a housing part around the inverter circuit board 4. The outside air taken into the interior of the body part 2a flows so as to pass through mainly the part between the rotor 3a and a stator 3b, sucked in from the rear of the rotor fan 13, flows in a radial direction of the rotor fan 13, and is discharged from slots 17c (see FIG. 2), which are formed in the housing part around the rotor fan 13, to outside of the housing 2. The inverter circuit board 4 is an substantially-circular double-sided board having a substantially the same shape as the motor 3, and a plurality of switching elements 5 such as FETs (Field Effect Transistors) and a rotation-position detecting element 14 such as a Hall IC are mounted on the board.

A trigger switch 6 is disposed at an inner upper part of a handle part 2b integrally extending at a substantially right angle from the body part 2a of the housing 2, and a switch board 7 is provided below the trigger switch 6. A control circuit board 8 provided with a function of controlling the speed of the motor 3 based on a pulling operation of the trigger switch 6 is housed in a lower part in the handle part 2b, and the control circuit board 8 is electrically connected to the battery 9 and the switch board 7. A circuit for drive control of the motor 3 is mounted on the control circuit board 8. The battery 9 such as a nickel-cadmium battery or a lithium-ion battery is detachably attached below the handle part 2b.

In the body part 2a of the housing 2 and the hammer case 32, the motor 3 and a transmission mechanism part (a reduction mechanism 20 and the rotary impact mechanism part 22), which transmits power of the motor 3 to the tip tool, are arranged and disposed in the axial direction of the motor 3. An end part of the anvil 30 is projecting from a tip part of the hammer case 32, and a tip tool such as a driver bit (not shown) is detachably inserted and fixed to the anvil angular-hole part 30c. The tip tool can be fixed to the anvil angular-hole part 30c by a single-step operation. As a different tip tool, a bolt-fastening bit can be also attached to the anvil angular-hole part 30c.

The reduction mechanism 20, which has planetary gears including a planetary gear and a ring gear, and the rotary impact mechanism part 22 are provided on the front side of the body part 2a and in the hammer case 32. The rotary impact mechanism part 22 is provided with a spindle 27 and a hammer 24. A rear end of a rotation mechanism using the reduction mechanism 20 and the rotary impact mechanism part 22 is supported by a bearing 19b and a front end of the rotation mechanism is retained by a metal 19a. When the trigger switch 6 is pulled to start the motor 3, the motor 3 starts rotation in a direction set by a normal/opposite switching lever 10, the rotative force of the motor is reduced by the reduction mechanism 20 and transmitted to the spindle 27, and the spindle 27 rotates at a predetermined speed. In this case, the spindle 27 and the hammer 24 are coupled by a publicly-known cam mechanism. This cam mechanism includes: a V-shaped spindle cam groove 25 formed on an outer peripheral surface of the spindle 27, a hammer cam groove 28 formed on an inner peripheral surface of the hammer 24, and balls 26 engaged with these cam mechanisms 25 and 28.

The hammer 24 is always energized forward by a spring 23. During rest, the hammer 24 is positioned with a gap away from an end face of the anvil 30 by an engagement between the balls 26 and the cam grooves 25 and 28. Not-illustrated projecting parts are symmetrically formed at two locations on mutually-opposed rotation planar surfaces of the hammer 24 and the anvil 30.

In a screwing operation of an impact mode, the rotative force of the motor 3 transmitted from the rotary shaft 3c is reduced by the planetary gear and the ring gear included in the reduction mechanism 20 and is transmitted to the spindle 27. When the spindle 27 is subjected to rotary drive, the rotation is transmitted to the hammer 24 via the cam mechanism, and, before the hammer 24 makes a half rotation, the projecting parts of the hammer 24 are engaged with the projecting parts of the anvil 30 and rotate the anvil 30. If relative rotation is generated between the spindle 27 and the hammer 24 by the engagement reaction force of the moment, the hammer 24 starts retraction toward the motor 3 side while compressing the spring 23 along the spindle cam groove 25 of the cam mechanism.

Then, when the projecting parts of the hammer 24 move over the projecting parts of the anvil 30 to cancel the engagement between them because of the backward movement of the hammer 24, the hammer 24 is rapidly accelerated in a rotation direction and to the front side by the elastic energy accumulated in the spring 23 and working of the cam mechanism in addition to the rotative force of the spindle 27. Then, the projecting parts of the accelerated hammer 24 are engaged again with the projecting parts of the anvil 30, and the hammer 24 and the anvil 30 start to rotate integrally. At this point, strong rotation impact force is applied to the anvil 30; therefore, the rotation impact force is transmitted to a screw, a bolt, or the like via the not-illustrated tip tool attached to the anvil angular-hole part 30c of the anvil 30. Thereafter, similar operations are repeated to repeatedly transmit the rotation impact force intermittently to the screw or bolt from the tip tool, and the screw or bolt is screwed to a not-illustrated member to be fastened such as a timber.

The battery 9 of a pack-type serving as a driving power source of the motor 3 is detachably attached to a lower end part of the handle part 2b. A plurality of battery cells composed of, for example, not-illustrated lithium-ion secondary batteries or nickel-cadmium secondary batteries are housed in the battery 9. The battery 9 is electrically connected to the inverter circuit board 4 via the trigger switch 6 provided at a part of the handle part 2b. The inverter circuit board 4 is electrically connected to a coil (for example, a star-connected three-phase coil) included in the stator 3b of the motor 3, and the rotor 3a is rotated in a predetermined direction when sequentially energized to predetermined phases. An inverter circuit including a known bridge circuit for distributing a drive current to the three-phase coil of the motor 3 is mounted on the inverter circuit board 4, and a control circuit consisting of a CPU, etc. which controls the inverter circuit is mounted on the control circuit board 8.

A switching mechanism used for switching of operation modes, i.e., the impact mode and an electronic pulse mode is provided in the rear of the hammer 24. Specifically, a slipping member 36, a stopper 41, and a pusher 45 are provided in the hammer case 32 and in the rear of the hammer 24, and the slipping member 36 is energized to the rear side (motor 3 side) by a switching spring 39 interposed between the slipping member 36 and a step part of the hammer case 32. A change lever 48b for operating the switching mechanism is provided outside of the hammer case 32.

By using the power tool 1 structured in the above described manner, when the “impact mode” is set by operating the change lever 48b and an operator pulls the trigger switch 6 while holding the handle part 2b, the trigger switch 6 is put in an on-state, and operation of the impact driver can be started. When a predetermined load torque or the torque higher than that is applied to the anvil 30 (tip tool) during screw fastening, the hammer 24 converts rotative force to impact force while being placed over the anvil 30 by working of the spring 23. As a result, rotation impact force is applied to the tip tool attached to the anvil 30, and a screw is fastened.

On the other hand, when the change lever 48b is operated to set the “electronic pulse mode” and the operator pulls the trigger switch 6 while holding the handle part 2b, the trigger switch 6 becomes an on-state, and operation of an electronic pulse driver can be started. In a screw fastening operation of the electronic pulse mode, the rotative force of the normal rotation and the opposite rotation of the motor 3 transmitted from the rotary shaft 3c is reduced by the reduction mechanism 20 having the planetary gear and the ring gear, and the hammer 24 applies rotation impact force to the anvil 30 (tip tool). During screw fastening, when predetermined load torque or the torque higher than that is applied to the hammer 24, the hammer 24 is promoted to move to the rear. However, backward movement of the hammer 24 is regulated by the stopper 41 via the slipping member 36; therefore, the hammer 24 is not placed over the anvil 30. Therefore, the motor 3 is controlled so as to alternately repeat normal rotation and opposite rotation by a control unit for carrying out rotation control of the motor 3. As a result, the hammer 24 applies rotation impact force to the tip tool attached to the anvil 30.

Next, the external shapes of the housing 2 and the hammer case 32 will be explained with reference to FIG. 2. In FIG. 2, the hammer case 32 is connected to the front side of the housing 2, thereby constituting the housing of the power tool 1. The change lever 48b for carrying out switching of the “impact mode” and the “electronic pulse mode” is provided at an upper part of the housing 2. The change lever 48b is movable in a circumferential direction along an outer peripheral surface of the hammer case 32. A recessed part (part recessed from the front to the rear of the housing 2) which defines a movable range of the change lever 48b is formed on the body part 2a of the housing 2. In a state in which the change lever 48b is abutting circumferential-direction end part 49a or 49b of the recessed part, the switching mechanism operates as the “impact mode” or the “electronic pulse mode”. In this case, the change lever 48b is positioned on the outer side (outer peripheral side) of the hammer case 32 housing a power transmitting part; therefore, opening of the hammer case 32 is not present in the movable range of the change lever 48b, and leakage of grease from the opening can be suppressed. A change member 48 in which the change lever 48b is formed is disposed so as to be inserted to the inner side of the housing 2 in vicinities of the peripheral end parts 49a and 49b. More specifically, in a vicinity of an arrow A in the vicinity of the circumferential-direction end part 49b, the housing 2 (non-movable member), the change member 48 (movable member), the hammer case 32 (non-movable member) are disposed so as to be overlapped in this order from the outer side of the radial direction; therefore, by virtue of the Labyrinth effect caused by the overlapping thereof, leakage of grease in the hammer case 32 to outside can be effectively suppressed.

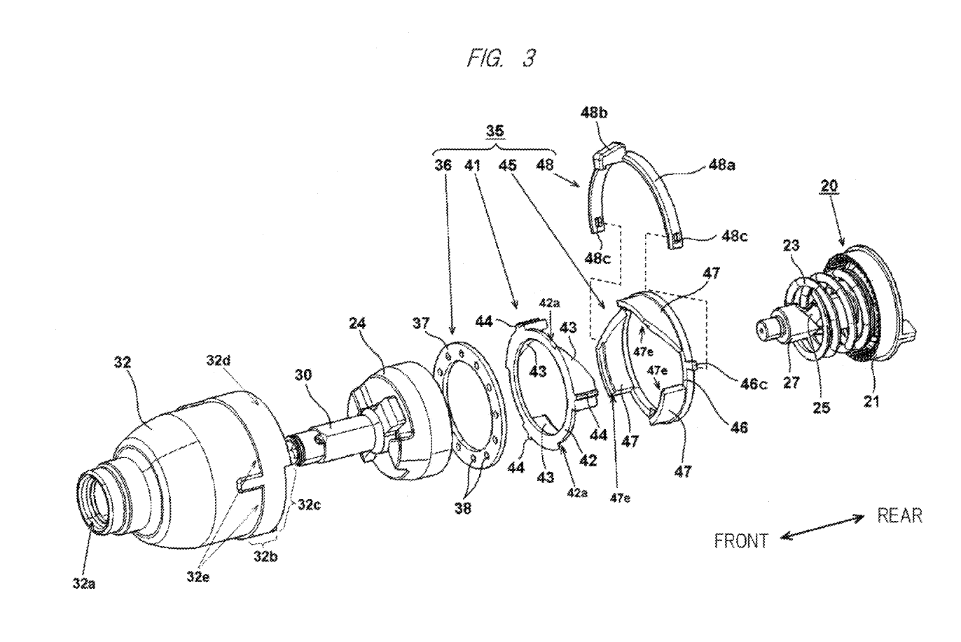

Next, a disassembled configuration of the hammer case 32, an impact mechanism part, and the switching mechanism 35 of the present embodiment will be explained with reference to FIG. 3. In the present embodiment, the switching mechanism 35 according to the present embodiment is incorporated between the reduction mechanism 20 and the hammer 24 of the mechanical impact mechanism part, which has been conventionally used. The switching mechanism 35 mainly includes four members. The stopper 41 is a member which moves to the front and the rear in the axial direction so as to cause the slipping member 36 disposed on the front side to abut the hammer 24 and limits movement of the hammer 24 to the rear in the axial direction. The pusher 45 is a member which changes the position thereof relative to the stopper 41 by rotating at 45 degrees or more, for example, at about 67 degrees in the rotation direction. The change member 48 has engagement holes 48c, which are provided at both end parts of an annular part 48a (a member having a shape formed by as if cutting a ring-like member into half), and the change lever (operation lever) 48b, which is provided in a vicinity of the center of the two engagement holes 48c. As illustrated by dotted lines in the drawing, the engagement holes 48c are engaged with projections 46c (only one of them is visible in the drawing), which are provided at two locations at diagonal positions in the circumferential direction of the pusher 45. The engagement structure of the change member 48 and the pusher 45 is not limited to the example illustrated in the drawing, the sides to which the recessed parts and the projecting parts are attached may be reversed, or another joint form may be adopted. The positions for providing the two engagement holes 48c are most preferable to be diagonally provided with respect to the rotation center (in other words, the positions at which the two engagement holes 48c are away from each other by 180 degrees); however, the angle may be equal to or less than 180 degrees, and they are only required to be provided to be away from the change lever 48b to some extent in the circumferential direction. The change member 48 serving as a switching member to change the operation mode of the transmission mechanism part (20, 22) from outside is disposed so as to extend to the transmission mechanism part (20, 22) in the hammer case 32 through a part between the housing 2 and the hammer case 32 (in a vicinity of the arrow A in FIG. 2).

The hammer case 32 is fixed in a vicinity of the front end of the housing 2. A flange part (outer peripheral part) 32b is formed at the periphery of the rear-side opening of the hammer case 32 (on the side where the opening of the cup-shaped hammer case 32 is present), and the step part 32e is formed in the front side of the flange 32b. A latching part having a substantially L-shaped cross-sectional shape and bent toward the inner side or a latching part having a recessed groove continued in the circumferential direction is provided at a part of the housing 2 for retaining the hammer case 32, and the latching part is retained so as to latch the step part 32e, thereby retaining the hammer case 32 so that the case is not removed from the housing 2 to the front side. In this manner, the flange part 32b is projecting from the hammer case 32 to the outer side, and the flange part 32b is fixed so as to be fitted in the latching part formed in an inner peripheral side of the housing 2. Upon impact by the impact mechanism part, the hammer case 32 is promoted to move to the front side with respect to the housing 2; however, this movement is prevented by the flange part 32b and the step or the recessed part of the latching part. Therefore, large tensile stress is generated in the hammer case 32 in the front of the step part 32e; however, stress is small in the rear of the step part 32e. A method of fixing the hammer case 32 to the housing 2 is not limited only to the method of the present embodiment, and another fixing method may be used.

The hammer 24 has a shape similar to that of a hammer of an impact driver which has been widely used, and the hammer 24 is attached to the spindle 27 via the cam mechanism. The spring 23 is provided in the rear side of the hammer 24, the spring 23 is positioned inside of the members of the switching mechanism 35, and the members of the switching mechanism 35 are disposed so as not to be in contact with the spring 23. The hammer case 32 is integrally formed of a metal such as an aluminum alloy. The hammer case 32 is provided with the through hole 32a which has a front-tapered shape and is for allowing the anvil 30 to penetrate therethrough. In the hammer case 32 in the present embodiment, recessed parts 32c cut-away toward the front side are formed partly at the periphery of the rear-side opening of the hammer case 32. The recessed parts 32c are formed in order to ensure space for allowing movement of the projections 46c of the pusher 45 and are diagonally formed at two locations of the hammer case 32. When the recessed parts 32c are formed in the flange part 32b, which is in the rear of the step part 32e, stress is not easily concentrated at the recessed parts 32c, and the hammer case 32 can be prevented from being broken. The change member 48 is disposed along the outer side of the vicinity of the outer peripheral surface 32d of the hammer case 32, and an annular part 46 of the pusher 45 is disposed in the inner peripheral side of the vicinity of the rear end part of the hammer case 32. The change member 48 and the pusher 45 are switching members which carry out switching by the switching mechanism 35, and the stopper 41 is a switched member which is to be switched.

The slipping member 36 includes a plurality of rollers 38 and a ring member 37, which is made of a synthetic resin and rotatably retains the rollers 38. The stopper 41 does not rotate with respect to the hammer 24, which rotates about the output-shaft rotary shaft; therefore, the slipping member 36 is inserted in order not to disturb rotation of the hammer 24 by the stopper 41 in a state in which the stopper 41 is moved forward and prevents backward movement of the hammer 24. Therefore, the shape of the slipping member 36 is not limited to the shape shown in the drawing; and the slipping member may be a bearing mechanism or a slipping mechanism having another shape as long as it is a bearing member that receives the force (thrust) that works in the axial direction of the hammer 24, which is a rotating body.

The stopper 41 is a metal member integrally includes, at three locations in the circumferential direction of an annular part 42 formed like a ring, cam members 43 at the three locations which are provided so as to project from the annular part 42 to the rear. In the present embodiment, the stopper 41 is movable to the front and rear (movable in the axial direction) by working of the pusher 45, and spline projections 44 are provided at three locations in the circumferential direction so as not to rotate in the rotation direction upon the movement. The spline projections 44 are engaged with spline grooves (not illustrated), which are formed on an inner wall part of the hammer case 32 and parallel to the axial direction, thereby stopping movement in the rotation direction but allowing movement in the axial direction of the stopper 41.

The pusher 45 is a member for moving the stopper 41 by pushing the stopper 41 from the rear to the front in the axial direction and is a metal member integrally includes cam members 47 at three locations, which are provided so as to project to the front from the annular part 46. The pusher 45 is rotatable in the circumferential direction about the rotation axis of the spindle 27, but does not move in the axial direction. This rotation in the circumferential direction is carried out when the operator operates the change lever 48b of the change member 48 connected to the pusher 45. In this case, each of the cam members 47 and the cam members 43 has a substantially trapezoidal shape when exploded in the circumferential direction, and the detailed shape thereof will be described later. Step parts 47e corresponding to step parts 42a (when viewed in the radial direction thereof, the parts in which the diameters of partial regions thereof are reduced) formed on the annular part 42 of the stopper 41 are formed at tips of the cam members 47. When the step parts 42a and the step parts 47e abut each other in this manner, a good contact state without rattling can be realized.

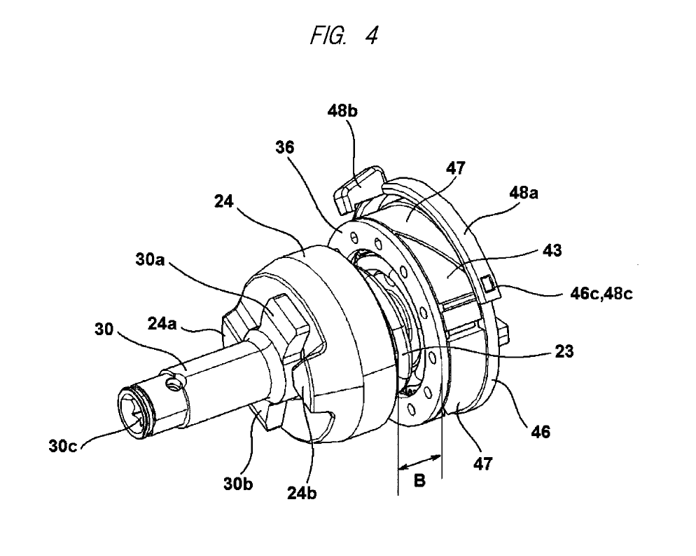

FIG. 4 is a perspective view of the impact mechanism part and the switching mechanism and is illustrating a position (normal position) upon an operation in the impact mode. As is understood from the drawing, an interval B between a front face of the slipping member 36 and a rear end face of the hammer 24 is sufficiently larger than the axial-direction thickness of projection parts 30a and 30b on which impacting faces of the anvil 30 are formed. By virtue of this positional relation, the hammer 24 can be retracted to the rear in the axial direction, the projecting parts 24a and 24b of the hammer 24 can move over the projecting parts 30a and 30b of the anvil 30, and normal mechanical impact operation can be carried out. In this process, the cam members 47 and the cam members 43 have a positional relation in which the members are alternately arranged in a row in the circumferential direction, and a distance between the annular part 42 of the stopper 41 and the annular part 46 of the pusher 45 is the shortest. In this manner, in the impact mode, the slipping member 36 and the stopper 41 are positioned in the rear, and the hammer 24 can be moved to the rear upon driving; therefore, normal impact striking can be carried out. During rotation of the motor 3, the slipping member 36, the stopper 41, and the pusher 45 are not moved both in the axial direction and the circumferential direction from the state of FIG. 4; therefore, the rotation operation of the hammer 24 is not adversely affected. Furthermore, since the slipping member 36 is always biased to the rear side by the switching spring 39 (see FIG. 1), resonance of the slipping member 36 caused by vibrations in fastening operation can be prevented.

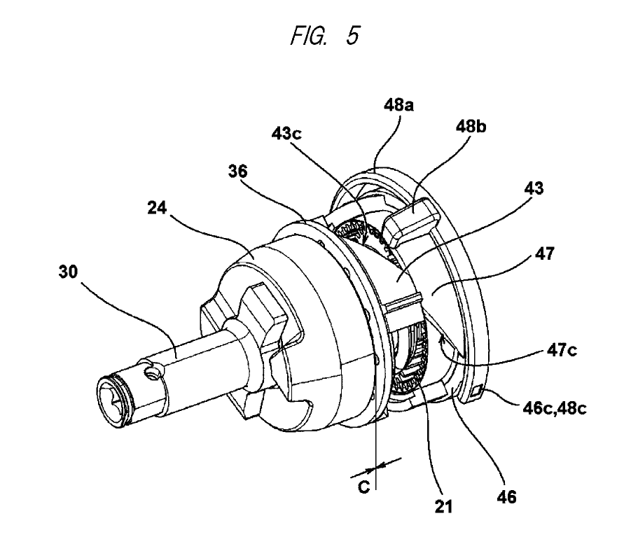

FIG. 5 is a perspective view of the impact mechanism part and the switching mechanism and is illustrating a position (lock position) of a case in which operation is carried out in the electronic pulse mode. As is understood from the drawing, an interval C between the front face of the slipping member 36 and the rear end face of the hammer 24 is almost zero. In this state, the hammer 24 cannot move backward; therefore, the normal impact operation which is carried out while the projecting parts 24a and 24b of the hammers 24 move over the projecting parts 30a and 30b of the anvil 30 cannot be carried out. Therefore, in this state, the anvil 30 is impacted by moving the hammer 24 with respect to the anvil 30 by a predetermined angle (however, less than 180 degrees) while alternately repeating the rotation of the motor 3 in the forward-rotation direction and the reverse-rotation direction. In other words, the impact operation in the so-called “electronic pulse mode” is carried out. In the state of FIG. 5, the rear end faces of the cam members 43 and the front end faces of the cam members 47 are in a mutually abutting state; therefore, the stopper 41 and the pusher 45 are disposed in series in the axial direction without being overlapped in the circumferential direction. In FIG. 5, the change lever 48b is not moved to the circumferential-direction end part 49a of the housing 2 (in other words, a state during movement), and the contact area of the rear end faces of the cam members 43 and the front end faces of the cam members 47 is somewhat small.

When changing the impact mode to the electronic pulse mode, the change lever 48b is rotated in the circumferential direction, and the state of FIG. 4 is switched to the state of FIG. 5. The rotating of the change lever 48b is transmitted to the pusher 45 via the projections 46c; and, as the pusher 45 rotates in the circumferential direction, inclined surfaces 47c of the cam members 47 and inclined surfaces 43c of the cam members 43 move while sliding to move the stopper 41 to the front. Along with the forward movement of the stopper 41, the sliding member 36 is also moved to the front and is fixed. A publicly-known retention mechanism (or a latch mechanism) which imparts a clicking sensation at a still position when the change lever 48b is moved may be provided. In this manner, in the electronic pulse mode, the slipping member 36, and the stopper 41 are positioned in the front side, and, upon driving of the motor 3, movement of the hammer 24 to the rear is regulated; therefore, the hammer 24 cannot be placed over the anvil 30, and pulse impact in accordance with the forward rotation and the reverse rotation which are electronic pulse operations can be carried out.

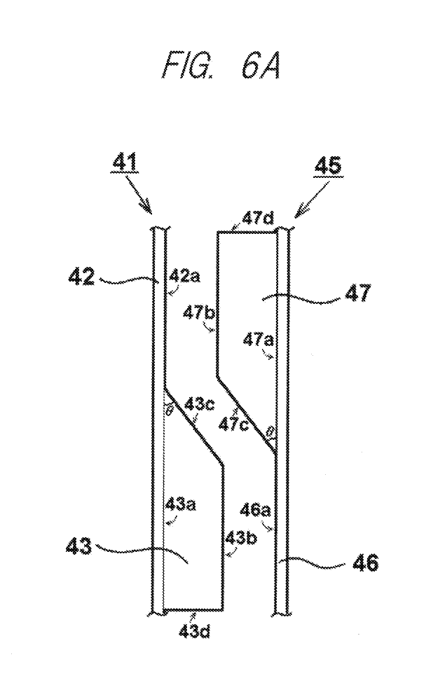

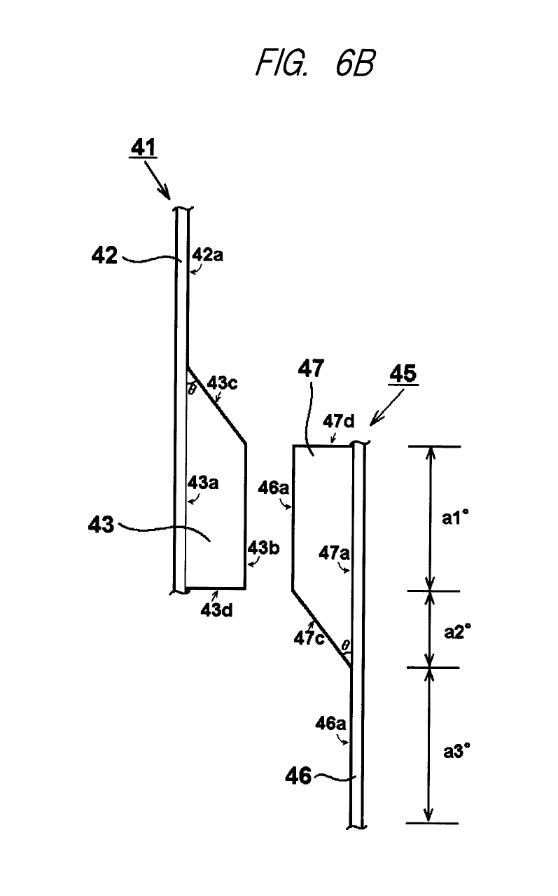

FIGS. 6A and 6B are schematic diagrams for explaining the shapes of the stopper 41 and the pusher 45 of the switching mechanism 35. FIG. 6A illustrates a relative positional relation of the stopper 41 and the pusher 45 in the state of FIG. 4. FIG. 6A illustrates a state, in which one third of the switching mechanism in the length of the circumferential direction is planarly exploded, for the convenience of explanation. To facilitate explanation, the interval between the stopper 41 and the pusher 45 is extremely widely illustrated, and the shapes, sizes, etc. of the cam members 43 and 47 are also roughly illustrated. In the stopper 41, the cam members 43 at the three locations are provided in the circumferential direction. The cam member 43 is a trapezoidal member having a lower base 43a, which is in contact with the annular part 42, and an upper base 43b, which is opposed thereto. Among the two sides connecting the upper base 43b and the lower base 43a of the trapezoidal part, the side 43d is provided at a right angle to the annular part 42, and the other side is formed as the inclined side (inclined surface) 43c. On the other hand, the pusher 45 side also has a similar trapezoidal shape, and the cam members 47 are provided at the three locations in the circumferential direction. The cam member 47 is a trapezoidal member having a lower base 47a, which is in contact with the annular part 46, and an upper base 47b, which is opposed thereto. Among the two sides connecting the upper base 47b and the lower base 47a of the trapezoidal part, the side 47d is provided at a right angle to the annular part 46, and the other side is formed as the inclined side (inclined surface) 47c. In this case, the angle

θ
formed by the side 43c and the annular part 42 and the angle
θ
formed by the side 47c and the annular part 46 are made equal to each other, and the lengths of the sides 43c and 47c, which are inclined parts, are mutually the same. In the normal position illustrated in FIG. 4, the flat surface part (the step part 42a shown in FIG. 3) of the annular part 4 and the upper base 47b abut each other, and a flat surface part 46a of the annular part 46 and the upper base 43b abut each other (In FIG. 6, they are separately illustrated to explain correspondence with reference symbols). When such a positional relation is used, the relative positions of the stopper 41 and the pusher 45, particularly, the relative interval between the annular parts 42 and 46 can be minimized.

FIG. 6B illustrates the relative positional relation of the stopper 41 and the pusher 45 in the state of FIG. 5 and illustrates a state in which the pusher 45 is rotated by a rotation angle of about 67 degrees from the state of FIG. 6A. When the pusher 45 is rotated from the state of FIG. 6A (in the exploded view of the drawing, the pusher 45 is moved downward), the pusher 45 rotates while the inclined sides 43c and 47c are in contact with each other; therefore, the stopper 41 is moved in the direction to be away from the pusher 45. Then, when the contact state of the inclined sides 43c and 47c is released, the upper bases 43b and 46a is put into a state in which the upper bases abut each other. In this state, the interval between the annular part 42 of the stopper 41 and the annular part 46 of the pusher 45 is twice as large as compared with that in the state of FIG. 6A.

In the working of the present invention, the shapes and the sizes of the cam members 43 and 47 can be arbitrarily set depending on the size of the impact mechanism part including the hammer 24. The degree of a rotation angle a2 degrees of the inclined sides 43c and 47c can be optionally set. In that case, if the rotation angle a2 degrees is ensured to be large to some extent, the force that is required for moving the change lever 48b can be reduced. If a rotation angle a1 degrees is ensured to be large to some extent, rigidity of the switching mechanism 35 upon retraction suppression of the hammer 24 can be increased. The shapes of the cam members 43 and 47 are not limited to trapezoidal shapes like the present embodiment. The shapes of the cam members to be achieved are comparatively optional as long as the cam members are provided with: surfaces which abut each other when the stopper 41 and the pusher 45 approach each other (for example, the upper base 43b and the flat surface part 46a, the step part 42a and the upper base 47b); surfaces which abut each other when the stopper 41 and the pusher 45 gets away from each other (for example, the upper base 43b and the upper base 46a); and working surfaces which convert the rotary motion of the pusher 45 to axial-direction locomotion of the stopper 41 (for example, the inclined surfaces 43c and 47c).

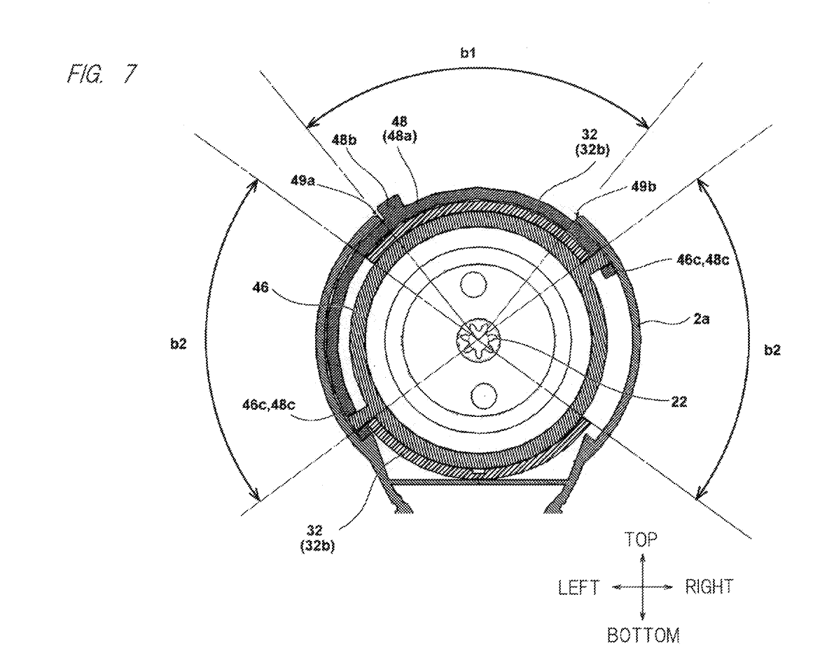

FIG. 7 is a cross-sectional view perpendicular to the axial direction that passes through the change member 48 of the switching mechanism 35. The change member 48 extends from outside of the housing 2 and the hammer case 32 to the transmission mechanism part (the reduction mechanism 20, the rotary impact mechanism part 22) in the hammer case 32 through the part between the housing 2 and the hammer case 32. The annular part 46 of the pusher 45 is provided inside of the outer peripheral surface 32d of the hammer case 32. The change member 48 is provided in the outer side of the outer peripheral surface 32d of the hammer case 32, and the change lever 48b is exposed to outside from the part between the circumferential-direction end parts 49a and 49b of the housing. In this case, the movable range of the change lever 48b is b1 when viewed in the rotation direction about the rotation axis. The engagement holes 48c of the change member 48 are engaged with the projections 46c of the annular part 46 in the body part 2a of the housing 2. In this case, the movable range of the projections 46c and the engagement holes 48c is b2 when viewed in the rotation direction about the rotation axis. Herein, the movable range b1 of the change lever 48b and the movable range b2 of the projections 46c and the engagement holes 48c are configured so as not to be mutually overlapped when viewed in the circumferential direction. In such an arrangement, the movable range of the change lever 48b is positioned in the outer peripheral side of the hammer case 32, the movable range of the contact location of the change member 48 and the pusher 45 is positioned on the inner peripheral side of the hammer case 32, and the ranges are set so as not to be mutually overlapped; therefore, an opening which is directly exposed to outside from the hammer case 32 can be eliminated, and the risk that grease therein leaks out to the outside from a gap in the vicinity of the change lever 48b can be significantly suppressed.

In this manner, the change member 48 has the annular part 48a, which is a ring-shaped part corresponding to a half cycle, and the change member 48 and the pusher 45 are engaged with each other by the projections 46c and the engagement holes 48c substantially diagonally in the body part 2a of the housing 2; therefore, the rotation operation of the change lever 48b can be stably transmitted to the rotation operation of the pusher 45. The pusher 45, which is rotated, has the annular part 46 and is engaged with the change member 48 by two points on of the annular part 46 in the substantially diagonal line; therefore, the pusher 45 can be stably operated by the two locations, and rotating of the pusher 45 can be smoothly carried out.

In the foregoing, the present invention has been concretely described based on the embodiments. However, it is needless to say that the present invention is not limited to the foregoing embodiments and various modifications and alterations can be made within the scope of the present invention.

According to an aspect of the present invention, in a power tool provided with a housing that houses a driving source and a case that houses a transmission mechanism part driven by the driving source and is partially covered with the housing, a switching member that changes an operation mode of the transmission mechanism part from outside extends from outside of the housing and the case to the transmission mechanism part in the case through a part between the housing and the case. The transmission mechanism part includes: a spindle that is rotated by the driving source; a hammer that is moved in an axial direction of the spindle while the hammer is being rotated by working of a cam mechanism provided on the spindle; an anvil to which rotative force and impact force are applied by the hammer; a spring that energizes the hammer to the anvil side; and a regulating unit that limits movement of the hammer in a direction opposite to the energizing direction of the spring. The regulating means switches the operation mode by the switching member. The regulating unit is a stopper disposed in the rear of the hammer, and the switching member includes a pusher that abuts the stopper and a change lever that rotates the pusher coaxially with a spindle. On a side, on which the pusher and the stopper are mutually abutting, of each of the pusher and the stopper, a working member that causes a relative interval between the stopper and the pusher to be adjustable by rotating the pusher is formed. The change lever is engaged with the pusher in an opening formed in the case, and an operation part of the change lever is projected to outside at a location other than an opening of the case. When viewed in a circumferential direction of the hammer case, a circumferential-direction movable range of the operation part is arranged so as not to be overlapped with a circumferential-direction movable range of an engagement part of the change lever and the pusher.

According to another aspect of the present invention, a recessed part that serves as a circumferential-direction movable region of the engagement part is formed in a rear end part of the hammer case. The change lever is an arc-shaped member being disposed along an outer wall of the hammer case and not being continued in a circumferential direction and has engagement parts formed to be engaged with pusher parts in vicinities of both ends of the arc-shaped member at, for example, two points of the arc-shaped member being substantially diagonal on a ring part. The operation part is provided substantially at the center of the two engagement parts of the change lever. An operation position of the operation part has a normal position that allows backward movement of the hammer and allows the anvil to carry out impacting and a lock position that prevents backward movement of the hammer with respect to the anvil. The pusher has a plurality of cam members projecting toward the front in the axial direction and along an annular member. The stopper has a plurality of cam members projecting toward the rear in the axial direction and along an annular member. The backward movement of the hammer is limited when the cam members are arranged in series in the axial direction, and the backward movement of the hammer is allowed when the cam members are alternately aligned in a circumferential direction.

According to another aspect of the present invention, when exploded, each of the cam members is a trapezoidal member, an inclined surface is formed on one of sides connecting an upper base and a lower base, and switching between the normal position and the lock position is carried out by relatively rotating the stopper with respect to the pusher while the inclined surfaces are brought into contact with each other. The cam members of the pusher and the stopper are disposed at three locations in the circumferential direction, and inclination angles of the inclined surfaces are mutually equal. Each of the circumferential-direction lengths of abutting surfaces when the cam members are arranged in series in the axial direction is preferable to be 45 degrees or larger in a circumferential angle. The driving source is a brushless motor and is provided with a control part that controls a rotation direction and a rotation speed of the brushless motor, and, at the lock position, the control part controls so as to carry out an impacting operation while the hammer is driven in normal-rotation and opposite-rotation directions. The hammer has a first impact mode in which the hammer carries out impact fastening in which the hammer is placed over the anvil upon impacting and a second impact mode in which the hammer carries out impact fastening in which the hammer is not placed over the anvil upon impacting. The case has a flange part formed in a cup shape continued in the circumferential direction at the opening of the case, a latch part formed to latch a step of the flange part at a front edge part of the housing, and the case is fixed to the housing by latching the flange part and the latch part, and a recessed part is formed to be closer to the opening than to the step of the flange part.

According to one of the other aspects of the present invention, the regulating unit that limits the backward movement of the hammer is provided, and the operation mode is switched by moving the regulating unit by the switching member; therefore, the power tool (electric power tool) having the plurality of operation modes is achieved.

According to one of the other aspects of the present invention, the switching mechanism part includes the stopper and the pusher disposed in the rear of the hammer, and, when the pusher is rotated, the stopper is moved to carry out switching. The change lever that rotates the pusher in the coaxial direction with the spindle is provided, the change lever being engaged with the pusher by the opening of the hammer case, and the operation part is projecting to the outside at a portion other than the opening of the hammer case. Therefore, when viewed from outside, the opening of the hammer case can be eliminated, and leakage of grease from the opening is thus suppressed.

According to one of the other aspects of the present invention, the circumferential-direction movable range of the operation part is not overlapped with the circumferential-direction movable range of the engagement part of the pusher. Therefore, since the operation part can be disposed at a position away from the opening for allowing penetration of the engagement part of the hammer case, leakage of grease from the opening part to the outside is suppressed.

According to one of the other aspects of the present invention, the change lever is the arc-shaped member that is disposed along the outer wall of the hammer case and is not continued in the circumferential direction, and has the engagement parts formed to be engaged with the pusher part in vicinities of the both ends of the arc-shaped member. The operation part is provided substantially at the center of the two engagement parts of the change lever. Therefore, the pusher can be stably operated at the two locations, and rotating of the pusher can be smoothly carried out.

According to one of the other aspects of the present invention, the operation position of the operation part has the normal position that allows backward movement of the hammer and allows the anvil to carry out impacting and the lock position that prevents the backward movement of the hammer with respect to the anvil. Therefore, the backward movement of the hammer can be easily limited by operating the operation part.

According to one of the other aspects of the present invention, the backward movement of the hammer is limited when the hammer is at the rotation position at which the cam members are arranged in series in the axial direction, and, when the cam members are alternately aligned in the circumferential direction, the backward movement of the hammer is allowed. Therefore, the interval of the stopper and the pusher can be easily adjusted only by relatively rotating the stopper and the pusher. Moreover, stable retention can be performed at the position after the adjustment.

According to one of the other aspects of the present invention, when the stopper is relatively rotated with respect to the pusher in the state in which the inclined surfaces of the cam members are in contact with each other, the switching between the normal position and the lock position is carried out. Therefore, the stopper can be easily moved in the axial direction with small force, and thus the switching mechanism with good operability is achieved.

According to one of the other aspects of the present invention, the cam members are respectively disposed at the three locations in the circumferential direction, and the stopper is not easily rattled and thus the stopper can be stably retained. The inclination angles of the inclined surfaces are mutually equal; therefore, the stopper can be smoothly moved in the axial direction.

According to one of the other aspects of the present invention, each of the circumferential-direction lengths of the abutting surfaces when the cam members are arranged in series in the axial direction is 45 degrees or larger in the circumferential angle; therefore, sufficient contact surfaces are ensured.

According to one of the other aspects of the present invention, at the lock position, the control part carries out the impact operation while driving the hammer in the forward-rotation and reverse-rotation directions. Therefore, an impact mechanism of an electronic pulse type is achieved by using an already used impact mechanism.

According to one of the other aspects of the present invention, since two impact modes are prepared, various fastening operations can be carried out with one power tool.

According to one of the other aspects of the present invention, the flange part continued in the circumferential direction is formed at the opening of the case, the latch part that latches the step of the flange part is formed at the front edge part of the housing, the case is fixed to the housing by latching them, and the recessed part is formed in the side close to the opening than to the step of the flange part. Therefore, stress is not easily concentrated on the recessed part, and the hammer case can be prevented from being broken.

In the above-described embodiment, the electric power tool which can use both of the functions of the impact driver and the electronic pulse driver has been proposed. However, the tool may be a tool that has the functions of an impact driver and a drill driver. In the above-described embodiment, the example of the electric power tool using a brushless motor as a driving source has been described as an example of the power tool. However, the tool may be an electric power tool using a motor equipped with a brush or may be a power tool using an air motor.

### REFERENCE SIGNS LIST

1 Power tool
2 Housing
2a Body part
2b Handle part
3 Motor
3a Rotor
3b Stator
3c Rotary shaft
4 Inverter circuit board
5 Switching element
6 Trigger switch
7 Switch board
8 Control circuit board
9 Battery
10 Forward/reverse switching lever
13 Rotor fan
14 Rotation-position detecting element
17a Air intake hole
17b, 17c Slot
18a, 18b Bearing
19a Metal
19b Bearing
20 Reduction mechanism
22 Rotary impact mechanism part
23 Spring
24 Hammer
24a, 24b Projecting part
25 Spindle cam groove
26 Ball
27 Spindle
28 Hammer cam groove
30 Anvil
30a, 30b Projecting part
30c Anvil angular-hole part
31 Attachment member
32 Hammer case
32a Through hole
32b Flange part
32c Recessed part
32d Outer peripheral surface
32e Step part
35 Switching mechanism
36 Member
37 Ring member
38 Roller
39 Switching spring
41 Stopper
42 Annular part
42a Step part
43, 47 Cam members
43a, 47a Lower base (of cam member)
43b, 47b Upper base (of cam member)
43c, 47c Inclined surface (of cam member)
43d, 47d Side (of cam member)
44 Spline projection
45 Pusher
46 Annular part
46a Flat surface part
46c Projection
47e Step part
48 Change member
48a Annular part
48b Change lever (operation part)
48c Engagement hole
49a, 49b Circumferential-direction end part

1. A power tool comprising:
a housing that houses a driving source; and
a case that houses a transmission mechanism part driven by the driving source and is partially covered with the housing,
wherein a switching member that changes an operation mode of the transmission mechanism part from outside extends from outside of the housing and the case to the transmission mechanism part in the case through a part between the housing and the case.

2. The power tool according to claim 1,
wherein the transmission mechanism part includes: a spindle that is rotated by the driving source;
a hammer that is moved in an axial direction of the spindle while the hammer is being rotated by working of a cam mechanism provided on the spindle;
an anvil to which rotative force and impact force are applied by the hammer;
a spring that energizes the hammer to the anvil side; and
a regulating unit that limits movement of the hammer in a direction opposite to an energizing direction of the spring, and
the regulating means switches the operation mode by the switching member.

3. The power tool according to claim 2,
wherein the regulating unit is a stopper disposed in the rear of the hammer,
the switching member includes a pusher that abuts the stopper and a change lever that rotates the pusher,
on a side, on which the pusher and the stopper are mutually abutting, of each of the pusher and the stopper, a working member that causes a relative interval between the stopper and the pusher to be adjustable by rotating the pusher is formed,
the change lever is engaged with the pusher in an opening formed in the case, and
an operation part of the change lever is projected to outside at a location other than an opening of the case.

4. The power tool according to claim 3,
wherein, when viewed in a circumferential direction of the hammer case, a circumferential-direction movable range of the operation part is arranged so as not to be overlapped with a circumferential-direction movable range of an engagement part of the change lever and the pusher.

5. The power tool according to claim 4,
wherein a recessed part that serves as a circumferential-direction movable region of the engagement part is formed in a rear end part of the hammer case,
the change lever is an arc-shaped member being disposed along an outer wall of the hammer case and not being continued in a circumferential direction and has engagement parts formed in vicinities of both ends of the arc-shaped member,
the operation part is provided substantially at the center of the two engagement parts of the change lever.

6. The power tool according to claim 4,
wherein an operation position of the operation part has a normal position that allows backward movement of the hammer and allows the anvil to carry out impacting and a lock position that prevents backward movement of the hammer with respect to the anvil.

7. The power tool according to claim 6,
wherein a working member of the pusher includes a plurality of cam members projecting toward the front in the axial direction and along an annular member,
a working member of the stopper includes a plurality of cam members projecting toward the rear in the axial direction and along an annular member,
the backward movement of the hammer is limited when the cam members are arranged in series in the axial direction, and
the backward movement of the hammer is allowed when the cam members are alternately aligned in a circumferential direction.

8. The power tool according to claim 7,
wherein, when exploded, each of the cam members is a trapezoidal member, an inclined surface is formed on one of sides connecting an upper base and a lower base, and switching between the normal position and the lock position is carried out by relatively rotating the stopper with respect to the pusher while the inclined surfaces are being brought into contact with each other.

9. The power tool according to claim 8,
wherein the cam members of the pusher and the stopper are disposed at three locations in the circumferential direction, and inclination angles of the inclined surfaces are mutually equal.

10. The power tool according to claim 9,
wherein each of the circumferential-direction lengths of abutting surfaces when the cam members are arranged in series in the axial direction is 45 degrees or larger in a circumferential angle.

11. The power tool according to claim 1,
wherein the driving source is a brushless motor and is provided with a control part that controls a rotation direction and a rotation speed of the brushless motor, and,
at the lock position, the control part controls so as to carry out an impacting operation while the hammer is being driven in normal-rotation and opposite-rotation directions.

12. The power tool according to claim 11,
wherein the hammer has a first impact mode in which the hammer carries out impact fastening in which the hammer is placed over the anvil upon impacting and a second impact mode in which the hammer carries out impact fastening in which the hammer is not placed over the anvil upon impacting.

13. The power tool according to claim 5,
wherein the case includes
a flange part formed in a cup shape continued in the circumferential direction at the opening of the case,
a latch part formed to latch a step of the flange part at a front edge part of the housing, and the case is fixed to the housing by latching the flange part and the latch part, and
a recessed part is formed to be closer to the opening than to the step of the flange part.
